(19) United States
(12) Patent Application Publication
(10) Pub. No.: US 2015/0092152 A1
(43) Pub. Date: Apr. 2, 2015

(54) EYEWEAR ATTACHMENT

(71) Applicant: Chad Eklof, Suisun City, CA (US)

(72) Inventor: Chad Eklof, Suisun City, CA (US)

(21) Appl. No.: 14/499,206

(22) Filed: Sep. 28, 2014

Related U.S. Application Data
(60) Provisional application No. 61/884,907, filed on Sep. 30, 2013.

(51) Int. Cl. G02C 3/00; G02C 5/16

(52) U.S. Cl. CPC G02C 3/003; G02C 5/16
USPC 351/114; 351/178

(57) ABSTRACT

A device including eyewear, said eyewear including at least one optical portion for covering a user's eye. The eyewear includes a receiving portion operable for attaching a length of fabric. Also included is a plurality of fabric straps attached to the receiving portions, with each fabric strap each having a length long enough for tying at least two of the fabric straps together. Certain embodiments include padding, said padding disposed about the optical portion so the user's eyes are protected when worn. The eyewear may be shaded, include corrective lenses, or formed from protective material.

### PRIORITY

This application claims the benefit of co-pending provisional application No. 61/884,907 entitled “Eyewear Attachment” by the same inventors, file Sep. 30, 2013 which is included by reference as if fully included herein.

### BACKGROUND

Conventional glasses are attached to a user by having a rigid arm attached to the optical portion and formed to secure the rigid portion about the wearer's ears. This tends to hold the glass wear in place until it is jarred enough to knock them loose. Devices have been commercialized that keep eyewear secure by attaching something over the molded ear portion and then draping it around the users head or neck. These devices generally only operate to keep the glasses secured to the user if they were to be knocked off. For example, some of these devices hold the glasses around a user's neck when not in use. Moreover, conventional eyewear is designed to fit behind the ears. Thus conventional eyewear may cause pain if headgear is worn. For example and without limitation, if a wearer of sunglasses also wears a motorcycle helmet, the helmet will push the ears against the eyewear which may cause irritation or pain.

In the optical, eyeglass, and eyewear industry there is a need for retainers for securing or retaining eyeglasses in place. These retainers would ideally maintain the eyeglasses on the wearer during vigorous activity, such as during participation in athletic activity. They would also provide an attractive appearance which may be altered when desired. It would also be desirable for an eyeglass retainer to be easily interchangeable between differing eyeglasses or lenses to allow for user flexibility with different eyewear.

### SUMMARY

A device including eyewear, said eyewear including at least one optical portion for covering a user's eye. The eyewear includes a receiving portion operable for attaching a length of fabric. Also included is a plurality of fabric straps attached to the receiving portions, with each fabric strap each having a length long enough for tying at least two of the fabric straps together. Certain embodiments include padding, said padding disposed about the optical portion so the user's eyes are protected when worn. The eyewear may be shaded, include corrective lenses, or formed from protective material.

The construction and method of operation of the invention, however, together with additional objectives and advantages thereof will be best understood from the following description of specific embodiments when read in connection with the accompanying drawings.

### DESCRIPTION

### Brief Description of the Drawings

FIG. 1 shows a user wearing one embodiment of an eyewear attachment.

FIG. 2 show an embodiment according to the current disclosure which includes padding around the eyewear.

### GENERALITY OF INVENTION

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques for the invention, and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

### LEXICOGRAPHY

The term “Eyewear” generally means items and accessories worn on or over the eyes, for fashion, or adornment, or protection against the environment, or to improve or enhance visual acuity. Common forms of eyewear include glasses (also called eyeglasses, or spectacles or corrective lenses), sunglasses (shaded), and the like. Eyewear may also include more utilitarian forms of eye protection, such as goggles.

### DETAILED DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

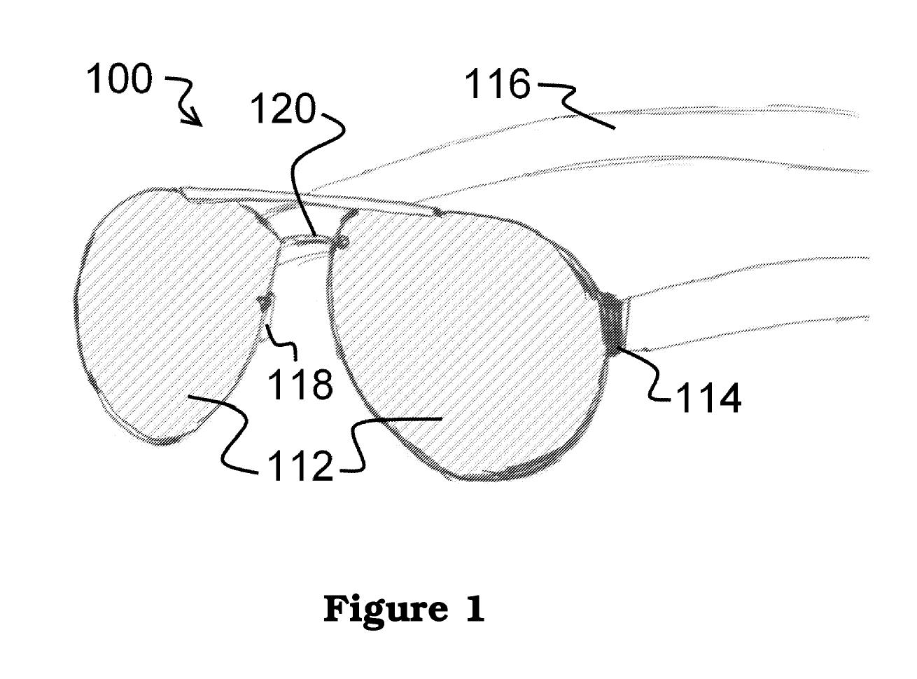

FIG. 1 shows an embodiment of an eyewear attachment 100. In FIG. 1 a user may wear eyewear 112 such as sunglasses, reading glasses and the like, positioned in front of the user's eyes. The eyewear consists of two optical portions connected through a nose bridge 120. The eyewear attachments “arms” or “straps” 116 may be made of fabric and are designed to be tied together on the back of the user's head. The illustration of FIG. 1 is by way of reference only and should not be read as limiting in any way. For example and without limitation, the eyewear may include sunglasses or eyeglasses or be used as an upgrade kit for a person's existing sunglass or regular glasses.

One embodiment of the present disclosure may be for the sunglasses/glasses 112 to have straps made of fabric 116, attached to a frame of the eyewear 114. In this embodiment the optical portions are secured or worn by bringing the opposite two corners of these fabric arms 116 together. The wearer simply centers the nose pad 118 of the glasses on his or her nose and guides the ends of the arms 116 around and over to the back of the head (similar to using a bandana or kerchief). The ends of each arm are tied together (granny knot or square knot will do) over or near the occipital bone at the base of the skull, or wherever desired. The wearer may position the knot for comfort and tuck the ends under for a more uniform or decorative knot. The wearer may use the arms 116 to collect hair that would otherwise be in his or her face. The fabric arms 116 may be longer than needed or long enough to fit different sized heads. The fabric arms 116 may attach to the eyewear by conventional means such as being sewn around a molded loop.

In the embodiment shown in FIG. 1 operates for more than securing the glasses in place. For example, there is no molded piece designed to conform to the user's ears. This has the advantage of not needing different sizes for each user because the fabric may be tied tighter for users with smaller heads. Moreover, the fabric may operate as a sweatband. By obviating the need to a solid piece behind the user's ears, headgear will not push the user's ears against their head and cause irritation.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

In another embodiment of the present disclosure the sunglasses/glasses may have optional VELCRO panels (not shown) to close the fabric arms 116 of the sunglasses/glasses around the user's head. In some embodiments the fabric arms 116 may be removable from the eyewear and interchangeable with other fabric arms. Moreover, the arms 116 may be attached to the eyewear at existing hinge points or directly to frame. In some embodiments the fabric arms 116 may fit or slide over existing solid arms and attach to frames with fasteners such as VELCRO, clips, screws or the like.

In yet another embodiment the fabric arms 116 may glow in the dark or the fabric arms may have glowing or reflective patches. Variations include but are not limited to arms of braided hair or different colors which may match the color of the frames or tint of the lenses.

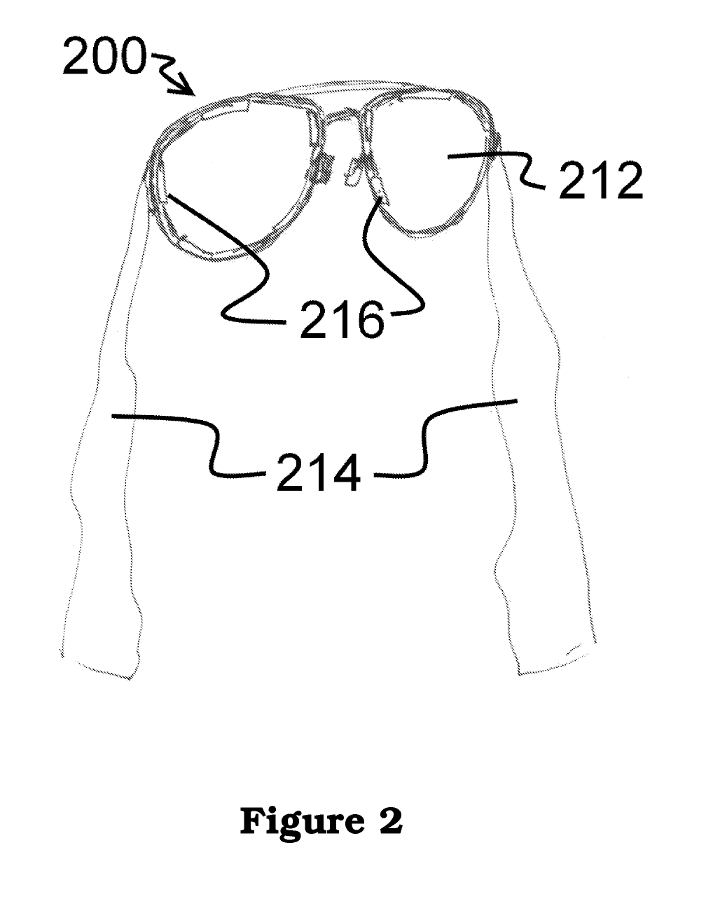

FIG. 2 show an embodiment 200 which includes padding around the eyewear. In FIG. 2 eyewear 212, such as glasses, sunglasses, safety glasses and the like, is attached to fabric arms 214. The fabric arms 214 may be attached to ends of the eyewear 216 and the eyewear may be slightly curved to conform to a user's face. Disposed on the eyewear is padding 216. The padding 216 material may be foam rubber, soft plastic, cloth and the like. The padding 216 is disposed about the eyewear 212 as to not block the vision of the user when the eyewear 212 is attached to the user's head by tying together the ends for the fabric 214. When worn, the padding 216 operates to soften the impact of wearing the eyewear because when tightly tied, the embodiment 200 may press against a user's forehead or cheeks and become uncomfortable. In addition the padding 216 prevents this embodiment 200 from being worn so tight that the user's eyelashes are restricted.

Additional embodiments may include a covering or head piece for wearer's ears which is attached to the frames or straps. for example and without limitation certain embodiments may incorporate a “do-rag” or similar headgear.

Some embodiments may have figures and/or logos on the side of the fabric straps, including flowers, animals, sports items, and cartoon characters. Moreover embodiments may include rhinestones, patches, trinkets and the like on the fabric arms.

One having skill in the art will appreciate that the fabric arms 214 may be effectuated using material other than fabric, including, but not limited to water-proof material. Also, different supports for eyewear 216 may be effectuate to facilitate attaching the fabric arms to the eyewear. For example and without limitation, multiple lens may an supported by a holder made of fabric such that the lenses are wearable over each eye without any solid structural support except for the fabric. Moreover, certain of the embodiments presented herein may allow for differing means to attach to lens. For example and without limitation, the fabric may be formed into multiple portions for attaching to the lens.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

I claim:

1. A device including:
eyewear, said eyewear including at least one optical portion, said eyewear including a receiving portion operable for attaching fabric;
a plurality of fabric straps attached to said receiving portions, said fabric straps each having a length long enough for tying at least two of the fabric straps together.

2. The device of claim 1 further including:
padding, said padding disposed about the optical portion.

3. The device of claim 1 wherein said eyewear is shaded.

4. The device of claim 1 wherein the eyewear includes corrective lenses.

5. The device of claim 1 wherein the eyewear is formed from protective material.

6. A method including:
forming a receiver on an optical portion of eyewear;
attaching at least one fabric portion to the receiver, and
disposing padding on the eyewear.
